(19) United States
(12) Patent Application Publication
(10) Pub. No.: US 2002/0052799 A1
(43) Pub. Date: May 2, 2002

(54) Customized customer design, development and ordering system

(76) Inventor: Vasiliy Starikov, Moscow (RU)

Correspondence Address: Richard C. Litman, LITMAN LAW OFFICES, LTD., P.O. Box 15035, Arlington, VA, 22215, US

(21) Appl. No.: 09/983,528

(22) Filed: Oct. 24, 2001

Related U.S. Application Data
(60) Provisional application No. 60/243,274, filed on Oct. 26, 2000.

(51) Int. Cl. G06F 17/60

(52) U.S. Cl. 705/26

(57) ABSTRACT

A customized customer design, development and ordering system. The system is made up of at least one server computer having a processor, an area of main memory for executing program code under the direction of the processor, a storage device for storing data and program code and a bus connecting the processor, the main memory and the storage device. A relational database is the storage device and a data communications device connected to the bus for connecting the server computer to the Internet. Developed software is provided that designs a model made of customized available components, that can easily confirm that the designed model is done to the user's satisfaction.

### CROSS-REFERENCE TO RELATED APPLICATION

This application claims the benefit of U.S. Provisional Pat. application Ser. No. 60/243,274, filed Oct. 26, 2000.

### BACKGROUND OF THE INVENTION

1. FIELD OF THE INVENTION

The present invention relates generally to Internet commerce, and more specifically to a customized customer design, development and ordering system.

2. DESCRIPTION OF THE RELATED ART

The Internet has made buying and selling goods and services as easy as clicking a mouse. Initially, the emphasis was on buying and selling simple goods and services. However, users of the Internet began to desire buying and selling sophisticated customized goods and services and getting involved with complex transactions. This is reflected in the related art described below.

U.S. Pat. No. 4,875,162 issued to Ferriter et al., describes the use of a method for the automatic interfacing of a conceptual design tool with a project management tool. The conceptual design tool provides for the early manufacturing involvement information needed to aid and improve the total design and manufacturing effort to produce a final product. The conceptual design tool is used to build and modify a product structure.

U.S. Pat. No. 5,225,987 issued to Thompson, describes a method and system for providing a descriptive recitation amounting to specific instructions to be followed at a given location for manually mounting and assembling of parts to build up a product of complex configuration in situ.

U.S. Pat. No. 5,444,844 issued to Inoue et al., describes an automatic figure drawing apparatus and method in a computer aided design system. An automatic figure drawing apparatus provides a data selection device for selecting figure drawing data of a figure, on the basis of assignment data, from memory in which a database of various dimensions of predetermined figure drawing subjects is built, and a figure drawing information production device for supplying figure drawing information of a parametric system to a figure drawing output device on the basis of the selected figure drawing data.

U.S. Pat. No. 5,592,375 issued to Salmon et al., describes a computer-implemented system for brokering transactions between sellers and a buyer of goods and services, including a database, a seller interface and a buyer interface. The database contains information, including multimedia information, descriptive of the goods and services. The seller interface enables the sellers to interactively enter information, including multimedia information, into the database. The buyers interface provides a knowledge-based interactive protocol, enabling the buyer to select and review the descriptive information from the database.

U.S. Pat. No. 5,842,178 issued to Giovannoli, describes the use of a computerized system forming a computer-based communications network of buyer and vendor members for processing requests for quotation for goods and services from network members or their representatives and for linking buyers to sellers through the computer-based communications network of network members, in accordance with filter conditions established by the computerized system.

U.S. Pat. No. 5,880,959 issued to Shah et al., describes a method for computer-aided design. The method includes the steps of representing a computer-aided design activity as a design cycle and defining a goal of the design activity. The method also includes the steps of defining alternate design steps toward achieving the goal. According to one embodiment, the design activity is represented as a graph containing the alternate design steps. According to this embodiment, a cost metric is assigned for each of the alternate design steps that includes elements representing relative costs of taking each of a plurality of paths in the graph.

U.S. Pat. No. 5,999,908 issued to Abelow, describes a product design module, which is embedded in products or services that contain a microprocessor and a facility for communication. The resulting two-way interactive media enables relationships to be built with individual customers and groups of customers through out a product's or service's lifecycle. Customers may also be provided with automatic, portable in-use to access to constantly updated information during product use, to increase user success and reduce costly and error-filled processes of acquiring product expertise.

Each of the patents describe a system that is useful in the area of computer aided design, the manual mounting and assembly of parts, as well as brokering transactions and processing requests for quotations of goods and services. However, what is really needed is a system that allows for a customized customer design, development and ordering of a sophisticated processed product.

None of the above inventions and patents, taken either singularly or in combination, is seen to describe the instant invention as claimed. Thus a solving the aforementioned problems is desired.

### SUMMARY OF THE INVENTION

The invention is a customized customer design, development and ordering system. The system is made up of at least one server computer having a processor, an area of main memory for executing program code under the direction of the processor, a storage device for storing data and program code and a bus connecting the processor, the main memory and the storage device. A relational database is the storage device and a data communications device connected to the bus for connecting the server computer to the Internet. Developed software is provided that designs a model made of customized available components, that can easily confirm that the designed model is done to the user's satisfaction.

It is another object of the invention to facilitate designing complex design projects.

It is a further object of the invention to allow the user and the provider to design complex projects more cost effectively, faster and with greater quality then simply going back and forth with design details over traditional methods.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an overview of a customized custom designed, development and ordering system, according to the present invention.

FIGS. 2A, 2B, 2C and 2D make up a flowchart of the steps that software from a customized custom designed, development and ordering system perform, according to the present invention.

Similar reference characters denote corresponding features consistently throughout the attached drawings.

### DETAILED DESCRIPTION OF THE PREFERRED EMBODIMENTS

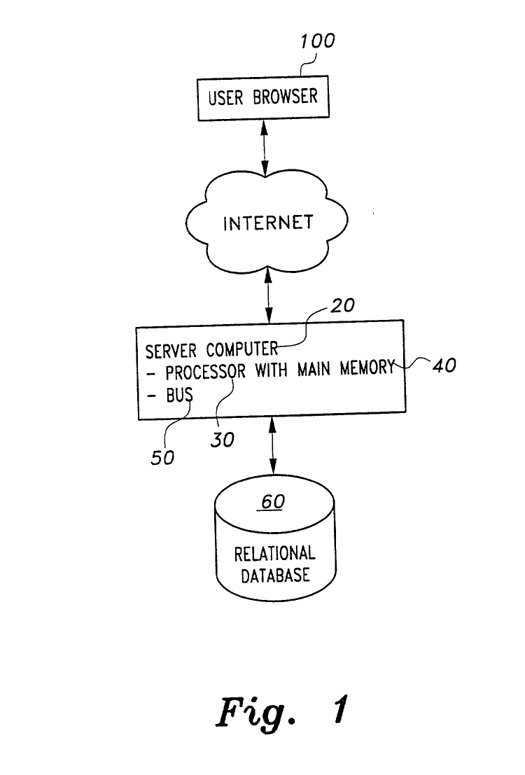

The present invention is a customized customer design, development and ordering system 10, as shown in FIG. 1.

The customized customer design, development and ordering system 10 comprises at least one server computer 20 having a processor 30, an area of main memory 40 for executing program code under the direction of the processor 30, a storage device for storing data and program code and a bus 50 connecting the main memory 40 and the storage device. A relational database 60 is the storage device and a data communications device is connected to the bus 50 for connecting the server computer 20 to the Internet.

This hardware utilizes a design, development and ordering computer program code 70 stored in the storage device and executing in the main memory 40 under the direction of the processor 30. The computer program code 70 includes means for allowing a user to provide data from a registration form on a registration Web page, means for filtering the data and registering the user, means for loading a relational database 60 with the user's data, means for logging in a user, means for sending the user components of a finished product being made and initial options for the user to select from, means for allowing a user to add, remove, edit and compose components to his full satisfaction, means for providing additional components when the user is not fully satisfied, means for filling out an order form and attaching a designed model and means for processing the order, paying for the order and the user getting the finished product.

A computer program product 80, such as a piece of computer software, that includes a medium readable by a processor 30, the medium having stored thereon a set of instructions for the customized customer design, development and ordering system 10. The steps that are done by the computer program product 80, include the following sequences of instructions: a first sequence of instructions which, when executed by the processor 30, causes the processor 30 to allow a user to provide data from a registration form on a registration Web page; a second sequence of instructions which, when executed by the processor 30, causes the processor 30 to filter the data and register the user; a third sequence of instructions which, when executed by the processor 30, causes the processor 30 to load a relational database 60 with the user's data; a fourth sequence of instructions which, when executed by the processor 30, causes the processor 30 to log in the user; a fifth sequence of instructions which, when executed by the processor 30, causes the processor 30 to send the user components of a finished product being made and initial options for the user to select from; a sixth sequence of instructions which, when executed by the processor 30, causes the processor 30 to allow a user to add, remove, edit and compose components to his full satisfaction; a seventh sequence of instructions which, when executed by the processor 30, causes the processor 30 to provide additional components when the user is not fully satisfied; an eighth sequence of instructions which, when executed by the processor 30, causes the processor 30 to fill out an order form and attach a designed model of the finished product; a ninth sequence of instructions which, when executed by the processor 30, causes the processor 30 to process the order, pay for the order and the having the user actually getting the finished product.

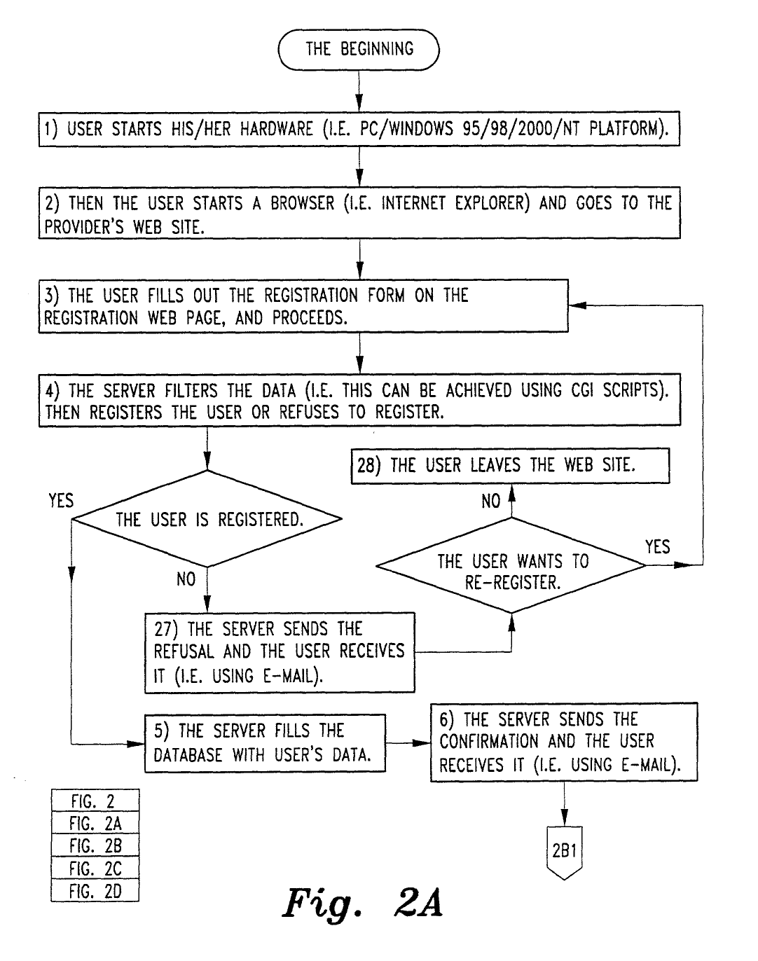

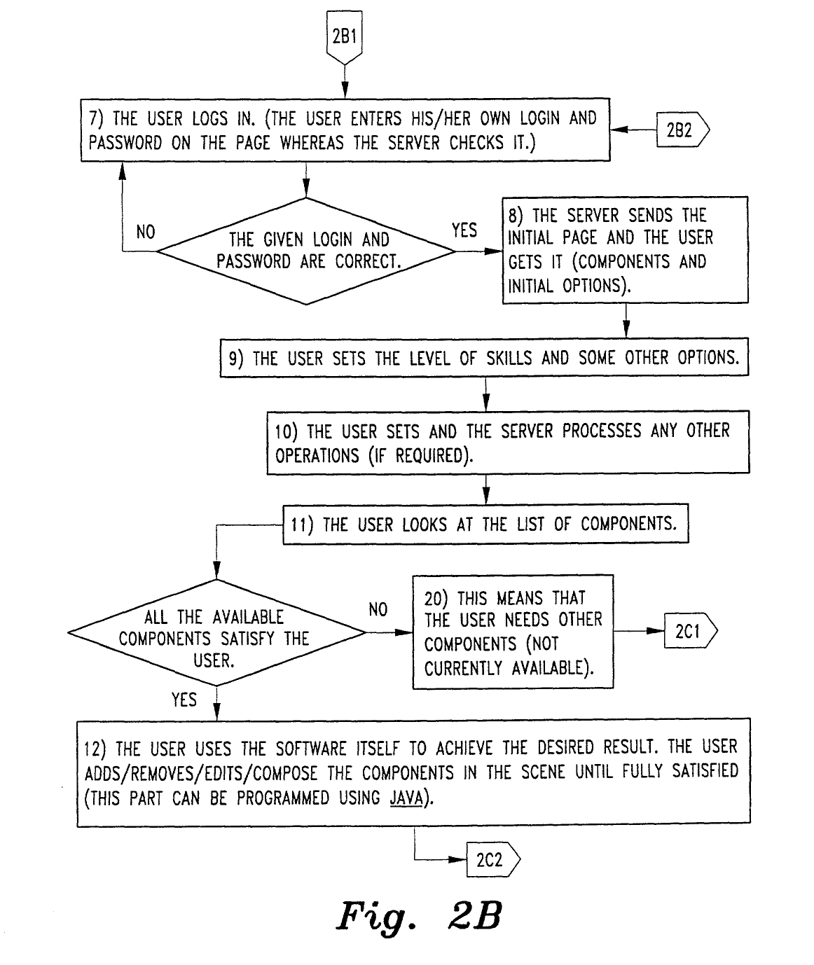

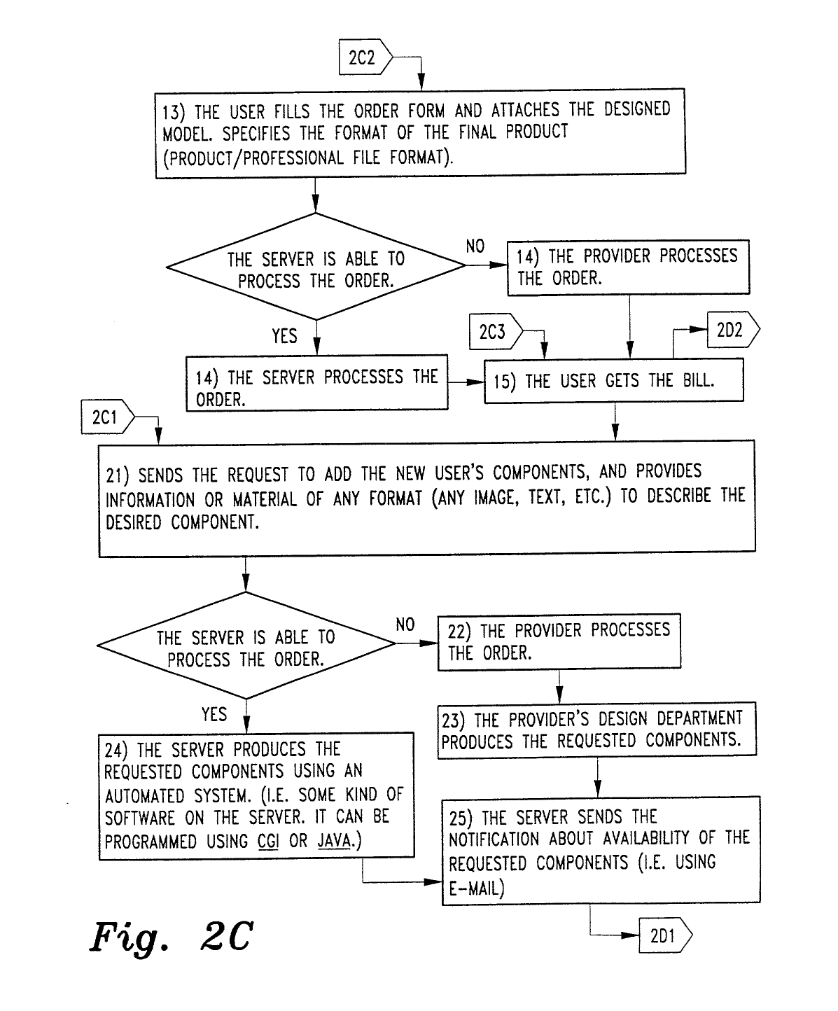

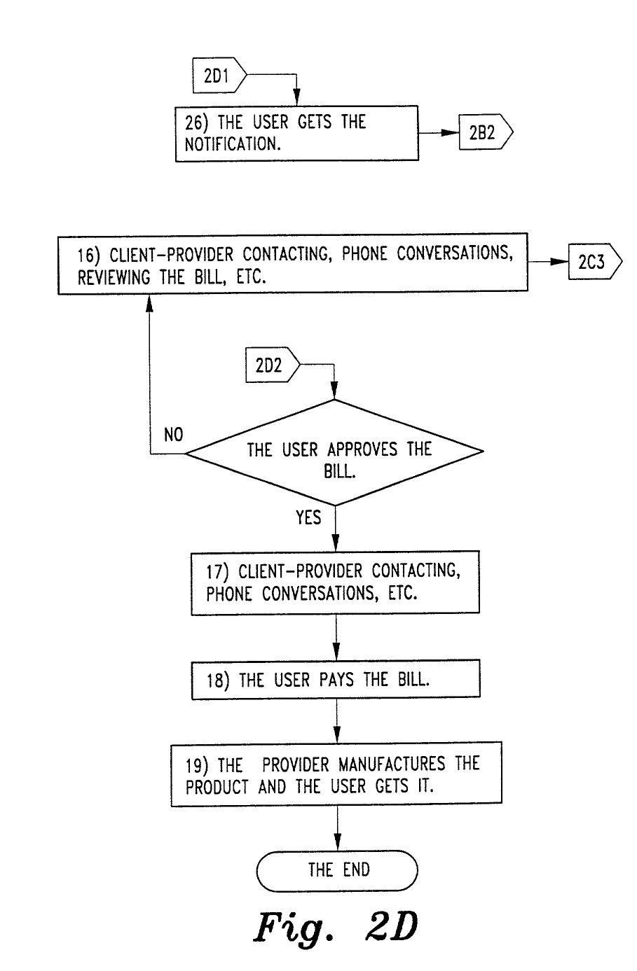

A computerized method for utilizing a customized customer design, development and ordering system 10 over the Internet, is outlined in FIGS. 2A-2D. In order for a user to use the Internet, the user would have to have a personal computer 90 with a Web browser 100 that can go to a provider's Web site. This is technology that is well-known to those schooled in the related art. The user would be someone who is interested in a provider's products and/or services and would allow the user to provide data from a registration form on a registration Web page.

The server computer 20 then filters the data using common gateway interface scripts, or CGI scripts, which help avoid registering unwanted users. Once filtered, the customized custom design, development and ordering system 10 then confirms or refuses to register the user. This is done with a reply or refusal directly to the user.

Once registered, a relational database 60 is loaded with the user's initial design data and the user logs in, typically with a designed login and password. The server computer 20 then sends the user an initial page of components and initial options for the user to select from. The user then requests a list of the levels of skills from the server computer 20, which forms the list of the levels of skills for the user to select. The level of skill includes accommodating everything from very simple two button systems to the use of integrated complex three dimensional graphics and text. Once a level of skill is selected, an interface is set accordingly to the level of skill chosen.

The user then requests a list of the available categories, which are formed by the server computer 20 and the relational database 60. The user then selects a category and requests the components for the selected category, which forms a compound object 110, that applies any kind of transformations to the loaded components. This is done through the use of appropriate programming commands that are done typically with Java script and C++.

Components can be divided into two groups, templates and elements. A template can be considered a basic object and can be edited in any way, including the content of the template (i.e. placing objects in a set of coordinates of the template) and editing the structure of the template (i.e. editing coordinates). An element is an object that may interact with a template in any way or be a property of a template. Templates and elements can be added to the available components by the user, with templates typically being forms and base objects and elements typically being images and text.

There is also a graphics engine 120, which controls the graphics and visual features of the components. Extensible markup language (XML) can be used to control the graphics engine 120. The graphics engine 120 enables the Web browser 100 to also process a special format of graphic data, which includes the use of three dimensional graphics such as MetaStream or virtual reality modeling language (VRML).

Once selected, the customized custom design, development and ordering system 10 will save the templates and elements in the relational database 60. Using JAVA programming language or C++, the user is allowed to add, remove, edit and compose components to his complete satisfaction. Once designed, the user can process the order, pay for the order and the user actually gets the finished product.

It is typical for a user to exchange detailed information about a product being made and designed. For example, a user may first brief the provider about the initial design and then receive a cost estimate of the planned work. The user may then have to approve the cost estimate and provide the provider with a rough layout of the design, which can then be revised by the user.

This type of “give and take” is typical for complex design projects, and can be more easily done with the customized custom design, development and ordering system 10 then simply sending information back and forth from user to provider. This is a key feature of the customized custom design, development and ordering system 10, which provides additional components and features to the initial components, allowing the user to produce a designed model of the finished product until the user is completely satisfied.

Once the user has gone back and forth with the provider and is completely satisfied, the user can then simply fill out an order form and attach a designed model of the finished product. Once the finished product or order is done, the provider can then process the order, pay for the order and have the user actually get the finished product. The user and the provider both usually work more cost effectively, faster and with greater quality then simply going back and forth with details over traditional methods.

It is to be understood that the present invention is not limited to the embodiments described above, but encompasses any and all embodiments within the scope of the following claims.

I claim:

1. A customized customer design, development and ordering system, comprising:
(a) at least one server computer having a processor, an area of main memory for executing program code under the direction of the processor, a storage device for storing data and program code and a bus connecting the processor, the main memory and the storage device;
(b) a relational database stored on said storage device;
(c) a data communications device connected to said bus for connecting said server computer to the Internet; and
(d) a design, development and ordering computer program code stored in said storage device and executing in said main memory under the direction of said processor, the computer program including:
(i) means for allowing a user to provide design data from a registration form on a registration Web page;
(ii) means for filtering the data and registering the user;
(iii) means for loading the relational database with the user's data;
(iv) means for logging in a user;
(v) means for sending the user components and initial options for the user to select from;
(vi) means for allowing a user to add, remove, edit and compose the components to his full satisfaction;
(vii) means for providing additional components when the user is not fully satisfied;
(viii) means for filling out an order form and attaching a designed model; and
(ix) means for processing the order, paying for the order and the user actually getting the finished product.

2. The system according to claim 1, wherein the system has a graphics engine.

3. The system according to claim 2, wherein the graphics engine is programmed with extensible markup language.

4. The system according to claim 1, wherein the components are programmed with Java script.

5. The system according to claim 1, wherein the components are programmed with C++.

6. A computer program product that includes a medium readable by a processor, the medium having stored thereon a set of instructions for a customized customer design, development and ordering system, comprising:
(a) a first sequence of instructions which, when executed by the processor, causes the processor to allow a user to provide data from a registration form on a registration Web page;
(b) a second sequence of instructions which, when executed by the processor, causes said processor to filter the data and register the user;
(c) a third sequence of instructions which, when executed by the processor, causes said processor to load a relational database with the user's data;
(d) a fourth sequence of instructions which, when executed by the processor, causes said processor to log in the user;
(e) a fifth sequence of instructions which, when executed by the processor, causes said processor to send the user components of a finished product being made and initial options for the user to select from;
(f) a sixth sequence of instructions which, when executed by the processor, causes said processor to allow a user to add, remove, edit and compose components to his full satisfaction;
(g) a seventh sequence of instructions which, when executed by the processor, causes said processor to provide additional components when the user is not fully satisfied;
(h) an eighth sequence of instructions which, when executed by the processor, causes said processor to fill out an order form and attach a designed model of the finished product;
(i) a ninth sequence of instructions which, when executed by the processor, causes said processor to process the order, pay for the order and the user actually gets the finished product.

7. A computerized method for utilizing a customized customer design, development and ordering system over the Internet, comprising the steps of:
(a) allowing a user to provide data from a registration form on a registration Web page;
(b) filtering the data and registering the user;
(c) loading a relational database with the user's data;
(d) logging in the user;
(e) sending the user component lists of a finished product being made and initial options for the user to select from;
(f) allowing a user to add, remove, edit and compose components his full satisfaction;
(g) providing additional components to the components when the user is unsatisfied;
(h) filling out an order form and attaching a designed model of the finished product; and
(i) processing the order, paying for the order and having the user actually getting the finished product.
